(19) United States
(12) Patent Application Publication
(10) Pub. No.: US 2009/0202796 A1
(43) Pub. Date: Aug. 13, 2009

(54) OUTCASE OF REFRIGERATOR AND METHOD FOR MANUFACTURING THE SAME

(76) Inventors: Ja-Hun Koo, Changwon-si (KR); Seung-min Ok, Changwon-si (KR); Jung-hun Kim, Busan (KR)

Correspondence Address: BIRCH STEWART KOLASCH & BIRCH, PO BOX 747, FALLS CHURCH, VA, 22040-0747, US

(21) Appl. No.: 12/304,726

(22) PCT Filed: Jun. 20, 2007
(86) PCT No.: PCT/KR07/02999

§ 371 Date: Dec. 12, 2008

(30) Foreign Application Priority Data
Jun. 21, 2006 (KR) 10-2006-0056108
Oct. 13, 2006 (KR) 10-2006-0099743
Oct. 18, 2006 (KR) 10-2006-0101266
Oct. 30, 2006 (KR) 10-2006-0105477
Nov. 6, 2006 (KR) 10-2006-0109118

(51) Int. Cl. B32B 3/10; B32B 17/00; B32B 15/18; B29C 53/00

(52) U.S. Cl. 428/209; 428/195.1; 428/210; 264/132

(57) ABSTRACT

The present invention discloses an outer casing of a refrigerator with various designs expressed thereon, and a method for manufacturing the same. The outer casing of the refrigerator includes a layer (17, 57, 77, 250, 370) defining the outward appearance of the refrigerator and having an image formed thereon. In this configuration, the outer casing of the refrigerator can be variously formed according to the tastes of the consumers to satisfy even the consumers preferring special splendid designs. Accordingly, the reliability of the product and the recognition of the product by the consumers increase.

### TECHNICAL FIELD

The present invention relates to an outer casing of a refrigerator, and more particularly, to an cater casing of a refrigerator with various images formed thereon, and a method for manufacturing the same.

### BACKGROUND ART

FIG. 1 is a view illustrating part of a door of a conventional refrigerator, and FIG. 2 is an enlarged view illustrating part of an cuter door of FIG. 1.

As illustrated, a door liner 20 is coupled to a back of an cuter door 10 for defining a front face of a door 1 of a refrigerator. A foaming agent is filled between the outer door 10 and the door liner 20 and solidified into an insulation layer 30, thereby the door 1 is manufactured.

Meanwhile, as illustrated in FIG. 2, a base plate 11 constituting the cuter door 10 is made of an iron sheet with a thickness of about 3 to 10 mm.

A rear film layer 13 is provided on the rear face of the base plate 11 which is the inner face of the cuter door 10. The rear film layer 13 serves to remove various contaminants, for example, rust by corrosion or dust from the rear face of the base plate 11. The rear film layer 13 is formed on the rear face of the base plate 11 by coating a phosphate at a thickness of about 50 μm.

A rear paint layer 15 is provided on the surface of the rear film layer 13. The rear paint layer 15 is formed on the surface of the rear film layer 13 by coating a paint at a thickness of about 20 μm. The rear paint layer 15 serves to protect the rear face of the base plate 11. In addition, the rear paint layer 15 substantially contacts the insulation layer 30, so that the cuter door 10 and the insulation door 30 are easily separated from each other in the disposal of the door 1.

In the meantime, a front paint layer 17 is provided on the front face of the base plate 11. The front paint layer 17 serves to protect the front face of the base plate 11. The front paint layer 17 includes a first front paint layer 17a and a second front paint layer 17b.

The first front paint layer 17a is formed on the front face of the base plate 11 by coating a paint at a thickness of about 50 μm, and the second front paint layer 17b is formed on the surface of the first front paint layer 17a by coating a paint at a thickness of about 20 to 25 μm. As the second front paint layer 17b is substantially exposed to the outside, it is preferable to use a color paint to form the second front paint layer 17b. On the contrary, the first front paint layer 17a is made of a transparent colorless paint in order to clearly express the color of the second front paint layer 17b.

In addition, a protection vinyl layer 19 is provided on the surface of the second front paint layer 17b. The protection vinyl layer 19 is made of a transparent or semi-transparent material with a thickness of about 50 to 100 μm, and adhered to the surface of the second front paint layer 17b. The protection vinyl layer 19 serves to protect the second front paint layer 17b.

However, the outer casing of the conventional refrigerator has the following disadvantages.

As described above, the base plate 11 is made of an iron sheet. It is thus impossible to express a special design on the front face of the outer door 10. That is, only the second front paint layer 17b of the predetermined color is externally seen. The color of the front face of the outer door 10 can be changed by the selection of the paint for the second front paint layer 17b. However, it is impossible to design the front face of the outer door 10 in various shapes or forms.

Such an iron sheet has a relatively dill color. A special design or pattern is not formed on the surface of the iron sheet, or is crudely formed thereon. It is thus difficult to create a tasteful or elegant image which the user wants.

Recently, the electric home appliances follow the trend toward a large size and a high quality. Particularly, a refrigerator, a Kimchi refrigerator and an air conditioner are recognized as parts of the interior. Therefore, they need more improved aesthetic appearances as well as basic operation performances.

### DISCLOSURE OF INVENTION

### Technical Problem

An object of the present invention is to provide an outer casing of a refrigerator with various designs expressed thereon, and a method for manufacturing the same.

Another object of the present invention is to provide an outer casing of a refrigerator which can define the three dimensional outward appearance of the refrigerator by using a glass member processed by an etching technique, and a method for manufacturing the same.

Yet another object of the present invention is to provide an outer casing of a refrigerator which can apply a target pattern to the exterior of the refrigerator according to the taste of the consumer, and a method for manufacturing the same.

Yet another object of the present invention is to provide an outer casing of a refrigerator which can form various designs and patterns by a print layer silk screen printed on a surface of a topmost layer of a steel sheet, and a method for manufacturing the same.

### Technical Solution

There is provided an outer casing of a refrigerator comprising a layer defining the outward appearance of the refrigerator and having an layer with an image formed thereon. In this configuration, various images can be expressed on the outer casing of the refrigerator to satisfy the aesthetic sense of the user.

In another aspect of the present invention, the layer with the image formed thereon is a base plate, and the outer casing further comprises: a rear film layer positioned on the rear face of the base plate; a rear paint layer positioned on the rear face of the rear film layer; and a front paint layer positioned on the front face of the base plate. In this configuration, the image can be formed on the base plate generally constituting the outer casing of the refrigerator, to thereby simply improve the outward appearance of the refrigerator.

In yet another aspect of the present invention, the image formed on the base plate is an uneven portion. In this configuration, the texture and volume of the uneven portion of the base plate can improve the outward appearance of the refrigerator.

In yet another aspect of the present invention, the uneven portion of the base plate is traced to the front paint layer to form an uneven portion thereon. In this configuration, the front paint layer does not only improve the color effect but also transfers the texture and volume of the uneven portion of the base plate.

In yet another aspect of the present invention, the front paint layer includes a first front paint layer formed on the front face of the base plate by coating a paint, and a second front paint layer formed on the surface of the first front paint layer by coating a paint. For example, the first front paint layer is a primer layer, and the second front paint layer is formed as a paint layer of a target color. In this configuration, the second front paint layer has sufficient adhesiveness to be easily adhered to the base plate.

In yet another aspect of the present invention, the front paint layer further includes a third front paint layer formed on the surface of the second front paint layer by coating a paint.

In yet another aspect of the present invention, the first and third front paint layers are formed by coating a transparent colorless paint, and the second front paint layer is formed by coating a predetermined color paint. Preferably, the uneven portion of the base plate is traced to the first and second front paint layers, and the third front paint layer is provided with a flat front face to which the uneven portion is not traced. In this configuration, the outer casing has the flat front face, while giving the texture and volume of the uneven portions of the base plate and the first and second front paint layers through the transparent third front paint layer.

In yet another aspect of the present invention, the outer casing of the refrigerator further includes a protection vinyl layer adhered to the surface of the third front paint layer. This configuration can prevent the outer casing of the refrigerator from being scratched.

In yet another aspect of the present invention, the layer with the image formed thereon is a glass member, and the image is formed by etching the glass member. In this configuration, the outer casing of the refrigerator has the special texture and volume by the etching of the glass member.

In yet another aspect of the present invention, the thickness of the glass member ranges from 5 to 10 mm.

In yet another aspect of the present invention, the outer casing of the refrigerator further includes a color steel sheet, and the layer with the image formed thereon is a silk screen print layer prepared by forming an image on the surface of the topmost layer of the color steel sheet with an ink for iron sheet. In this configuration, as the silk screen printing is conducted on the topmost layer of the color steel sheet, various color steel sheets can be used.

In yet another aspect of the present invention, the color steel sheet is any one of a VCM steel sheet, a PCM steel sheet and a PET steel sheet.

In yet another aspect of the present invention, the outer casing of the refrigerator further includes a clear layer formed on the top face of the silk screen print layer by coating a transparent synthetic resin, for protecting the silk screen print layer. In this configuration, the clear layer can protect the silk screen printing and show the silk screen printed image as it is.

In yet another aspect of the present invention, the ink for iron sheet is any one of oil enamel, alcohol resin enamel and metal ink.

In yet another aspect of the present invention, the silk screen print layer includes a plurality of silk screen print layers with different images sequentially silk screen printed thereon. In this configuration, the outer casing of the refrigerator can improve the aesthetic effect by using the plurality of colors.

In addition, there is provided a method for manufacturing an outer casing of a refrigerator, including the steps of: forming an image on at least one layer of the cuter casing of the refrigerator; and molding the outer casing of the refrigerator including the layer with the image formed thereon. By this method it can be manufactured that the outer casing of the refrigerator with the improved aesthetic appearance.

In another aspect of the present invention, the step of forming the image includes a process of forming a predetermined image on a base plate.

In yet another aspect of the present invention, the process of forming the predetermined image on the base plate is a process of forming an uneven portion on the base plate by rolling the base plate with a rolling roller. According to this method, the image can be easily formed on the base plate by the uneven portion.

In yet another aspect of the present invention, the step of forming the image further includes the processes of forming a rear film layer on the rear face of the base plate, forming a rear paint layer on the rear face of the rear film layer, and forming a front paint layer on the front face of the base plate. The order of performing the processes can be variously changed. For example, the rear film layer and the rear paint layer of the base plate can be formed before the front paint layer, and vice versa. In addition, after the image is formed on the base plate, the front paint layer may be formed. Alternatively, after the front paint layer is formed on the base plate, the image may be formed on the front paint layer and the base plate.

In yet another aspect of the present invention, the process of forming the front paint layer includes a first front paint layer formation process of coating a transparent colorless paint on the front face of the base plate, and a second front paint layer formation process of coating a predetermined color paint on the surface of the first front paint layer.

In yet another aspect of the present invention, the step of forming the image includes a process of sketching the image on a glass member, and a process of performing an etching along the sketched image. By this method it can be manufactured that the outer casing of the refrigerator which can improve the aesthetic effect by variously reflecting light through the etched image.

In yet another aspect of the present invention, the etching process etches the glass member by using a high pressure fine sand wind.

In yet another aspect of the present invention, the etching process etches the glass member by corrosion using a chemical agent.

In yet another aspect of the present invention, the etching process etches the glass member by corrosion using hydrogen fluoride.

In yet another aspect of the present invention, the step of forming the image includes a process of forming a silk screen print layer by performing a silk screen printing on a topmost layer of a material with an ink for iron sheet.

### ADVANTAGEOUS EFFECTS

In accordance with the outer casing of the refrigerator and the method for manufacturing the same, a predetermined pattern can be formed on the front face of the base plate constituting the outer door. Therefore, the outer casing of the refrigerator can be manufactured in various designs to satisfy the aesthetic demand of the user.

In accordance with the outer casing of the refrigerator and the method for manufacturing the same, the etching processed image is formed on the glass member for defining the outward appearance of the refrigerator, which improves the outward appearance of the refrigerator and increases the product value.

The image can be variously changed according to the tastes of the consumers to satisfy even the consumers preferring special splendid designs. Accordingly, the reliability of the product and the recognition of the product by the consumers increase.

In accordance with the outer casing of the refrigerator and the method for manufacturing the same, the special design or pattern can be expressed by forming the print layer at the topmost portion of the color steel sheet according to the silk screen printing method, which has the following advantages.

First, various and abundant patterns and colors can be expressed according to the silk screen printing method as compared with a gravure printing method, to thereby more improve the aesthetic effect.

Second, the working process as well as the facilities are simplified to reduce the whole manufacturing time. As the product is produced at a lower cost, productivity and cost efficiency are expected to increase.

Third, new designs and patterns are easily developed and the development process thereof is shortened, so that the manufacturer can quickly release a new product onto the market and sensitively respond to the market.

Fourth, the print layer can be formed on the surface of the color steel sheet. Therefore, the print layer can be formed not only on the VCM steel sheet but also on the PCM steel sheet and the PET steel sheet which are low priced but similarly define the outward appearance, to thereby secure the price competitiveness of the product.

### BRIEF DESCRIPTION OF THE DRAWINGS

FIG. 1 is a view illustrating part of a door of a conventional refrigerator;

FIG. 2 is an enlarged view illustrating part of an outer door of FIG. 1;

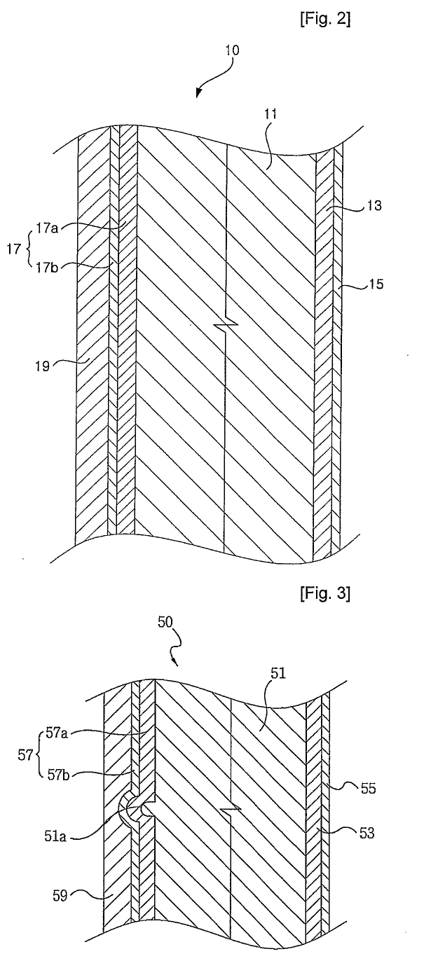

FIG. 3 is a view illustrating part of an outer casing of a refrigerator in accordance with one embodiment of the present invention;

FIGS. 4 to 9 are process views illustrating a process of manufacturing the outer casing of the refrigerator according to the one embodiment of the present invention by a method for manufacturing an outer casing of a refrigerator in accordance with a preferred embodiment of the present invention;

FIG. 10 is a view illustrating part of an outer casing of a refrigerator in accordance with another embodiment of the present invention;

FIGS. 11 to 17 are process views illustrating a process of manufacturing the outer casing of the refrigerator according to the another embodiment of the present invention by a method for manufacturing an outer casing of a refrigerator in accordance with a preferred embodiment of the present invention;

FIG. 18 is a view illustrating a refrigerator with an outer casing in accordance with one embodiment of the present invention;

FIG. 19 is a view illustrating part of the outer casing of the refrigerator in accordance with the one embodiment of the present invention;

FIG. 20 is a flowchart showing a process of manufacturing the outer casing of the refrigerator in accordance with the one embodiment of the present invention;

FIG. 21 is a configuration view illustrating an outer casing of a refrigerator in accordance with another embodiment of the present invention;

FIG. 22 is a configuration view illustrating an outer casing of a refrigerator in accordance with yet another embodiment of the present invention; and

FIG. 23 is a configuration view illustrating an outer casing of a refrigerator in accordance with yet another embodiment of the present invention.

### MODE FOR THE INVENTION

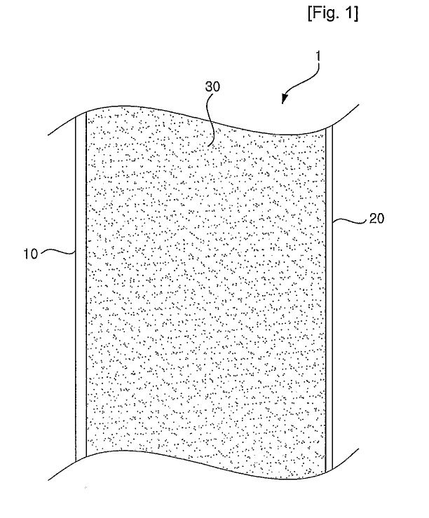

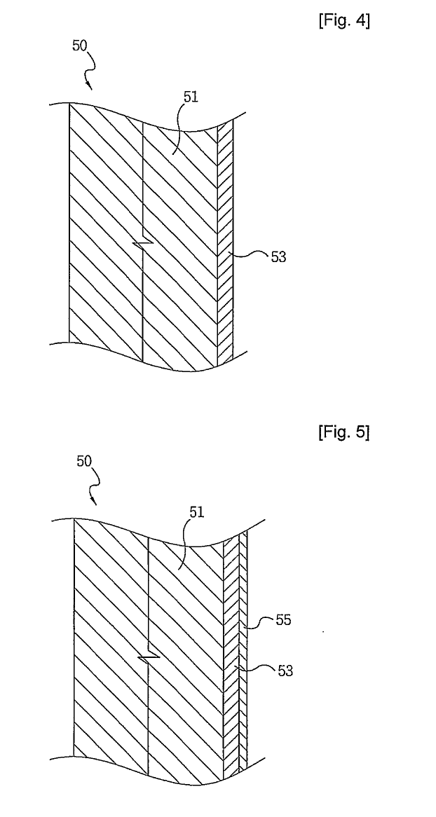

FIG. 3 illustrates an outer casing of a refrigerator in accordance with a preferred embodiment of the present invention. In the following description, same drawing reference numerals are used for the same elements as those of FIG. 1.

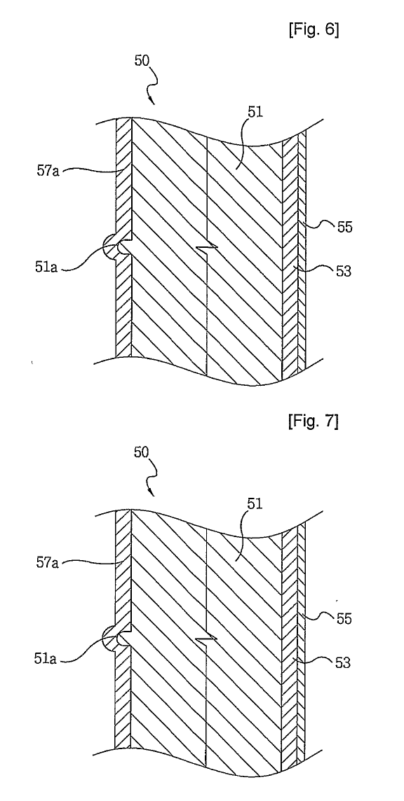

Referring to FIG. 3, a base plate 51 of an outer casing 50 for defining an outward appearance of a refrigerator is made of an iron sheet with a thickness of about 3 to 10 mm. A predetermined pattern 51a is formed on the front face of the outer casing 50. While the base plate 51 is rolled by rolling rollers (60 and 60′, refer to FIG. 4), the front face of the base plate 51 is compressed in a shape of an uneven portion 61 of the outer circumference of the rolling roller 60 closely adhered to the front face of the base plate 51, and thus provided with the pattern 51a.

For example, if the uneven portion 61 of the rolling roller 60 is formed in a wave shape, the pattern 51a is formed in a wave shape on the front face of the base plate 51. Here, the thickness of the pattern 51a of the base plate 51 is determined in consideration of the thickness of the base plate 51. Preferably, the pattern 51a has a relatively smaller thickness than a first front paint layer 57a explained later.

A rear film layer 53 is provided on the rear face of the base plate 51. The rear film layer 53 is formed on the rear face of the base plate 51 by coating a phosphate at a thickness of about 50 μm. The rear film layer 53 serves to remove various contaminants such as rust by corrosion or dust from the rear face of the base plate 51.

A rear paint layer 55 is provided on the rear face of the rear film layer 53. The rear paint layer 55 serves to protect the rear face of the base plate 51. The rear paint layer 55 is formed on the rear face of the rear film layer 53 by coating a paint at a thickness of about 20 μm.

A front paint layer 57 is provided on the front face of the base plate 51. The front paint layer 57 protects the front face of the base plate 51 and substantially defines the front face of the outer casing 50. The front paint layer 57 has a color to be displayed externally. The front paint layer 57 includes a first front paint layer 57a and a second front paint layer 57b.

The first front paint layer 57a is formed on the front face of the base plate 51 by coating a paint at a thickness of about 50 μm, and the second front paint layer 57b is formed on the rear face of the first front paint layer 57a by coating a paint at a thickness of about 20 to 25 μm. The first front paint layer 57a is made of a transparent colorless paint, but the second front paint layer 57b is made of a predetermined color paint. As the first front paint layer 57a and the second front paint layer 57b are coated very thin, the image formed on the base plate 51 as the uneven portion is traced thereon at it is.

In addition, a protection vinyl layer 59 is provided on the surface of the second front paint layer 57b. The protection vinyl layer 59 serves to protect the second front paint layer 57b. The protection vinyl layer 59 is a transparent or semitransparent vinyl sheet with a thickness of about 50 to 100 μm, and is adhered to the surface of the second front paint layer 57b. As the protection vinyl layer 59 is transparent or semitransparent, the image formed on the base plate 51 as the uneven portion and traced on the first front paint layer 57a and the second front paint layer 57b can be externally seen. Accordingly, the image formed on the base plate 51 as the uneven portion can improve the aesthetic effect for the user.

A method for manufacturing an outer casing of a refrigerator according to a preferred embodiment of the present invention will now be explained in detail with reference to the attached drawings.

FIGS. 4 to 9 illustrate a process of manufacturing an cuter door by the method for manufacturing the outer casing of the refrigerator in accordance with the preferred embodiment of the present invention.

As shown in FIGS. 4 to 9, while a base plate 51 passes between rolling rollers 60 and 60′ to be rolled, a pattern 51a is formed on the front face of the base plate 51. That is, the front face of the base plate 51 is compressed in a shape of an uneven portion 61 of the outer circumference of the rolling roller 60 closely adhered to the front face of the base plate 51, and thus provided with the pattern 51a.

In a state where the pattern 51a is formed on the front face of the base plate 51, a rear film layer 53 is formed on the rear face of the base plate 51 by coating a phosphate at a thickness of about 50 μm. A rear paint layer 55 is formed on the rear face of the rear film layer 53 by coating a paint at a thickness of about 20 μm.

Meanwhile, a first front paint layer 57a is formed on the front face of the base plate 51 by coating a transparent colorless paint at a thickness of about 50 μm. A second front paint layer 57b is formed on the surface of the first front paint layer 57a by coating a predetermined color paint at a thickness of about 20 to 25 μm.

At last, a protection vinyl layer 59 which is a vinyl sheet with a thickness of about 50 to 100 μm is adhered to the surface of the second front paint layer 57b, thereby finishing manufacturing of the outer casing 50. A door liner is coupled to the back of the outer casing 50, and a foaming agent filled between the outer casing 50 and the door liner is solidified into an insulation layer, to thereby finish manufacturing of the door of the refrigerator.

An outer casing of a refrigerator according to another embodiment of the present invention will now be described with reference to the attached drawings.

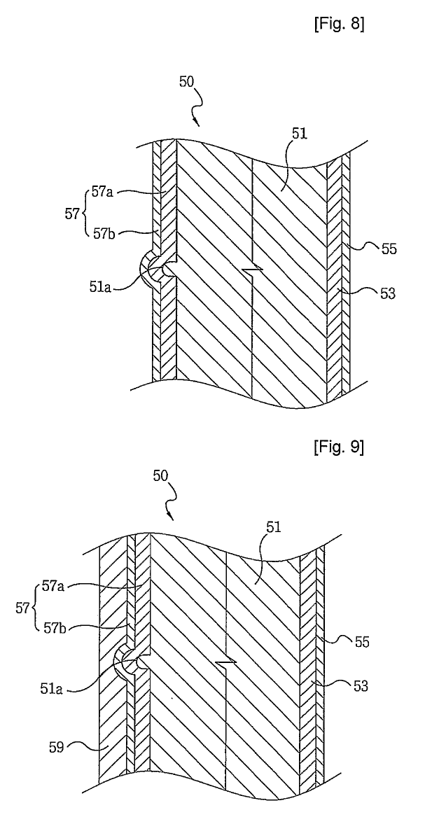

FIG. 10 illustrate the outer casing of the refrigerator in accordance with another embodiment of the present invention.

As depicted in FIG. 10, a rear film layer 73 and a rear paint layer 75 are sequentially provided on a rear face of a base plate 71. First and second front paint layers 77a and 77b are provided on the front face of the base plate 71. This configuration is identical to the embodiment of FIG. 3.

However, in this embodiment, a third front paint layer 77c is further provided on the surface of the second front paint layer 77b. That is, the front paint layer 77 provided on the front face of the base plate 71 includes the first to third front paint layers 77a to 77c. It is because, when the first and second front paint layers 77a and 77b are provided on the front face of the base plate 71, a pattern 71a is formed on the front face of the base plate 71.

That is, in a state where the first and second front paint layers 77a and 77b are provided on the front face of the base plate 71, while the base plate 71 is rolled by rolling rollers (80 and 80′, refer to FIG. 6), the pattern 71a is compressively formed in a shape of an uneven portion 81 of the outer circumference of the rolling roller 80 closely adhered to the front face of the base plate 71. Therefore, cracks or scratches may be generated on the first and second front paint layers 77a and 77b. Accordingly, differently from the embodiment of FIG. 3, the third front paint layer 77c is provided on the surface of the second front paint layer 77b, for offsetting such cracks or scratches.

The third front paint layer 77c is formed on the surface of the second front paint layer 77b by coating a paint at a thickness of about 5 to 20 μm. The third front paint layer 77c is made of a transparent colorless paint so as to externally show the color of the second front paint layer 77b.

A method for manufacturing an outer casing of a refrigerator according to another embodiment of the present invention will now be explained in detail with reference to the attached drawings.

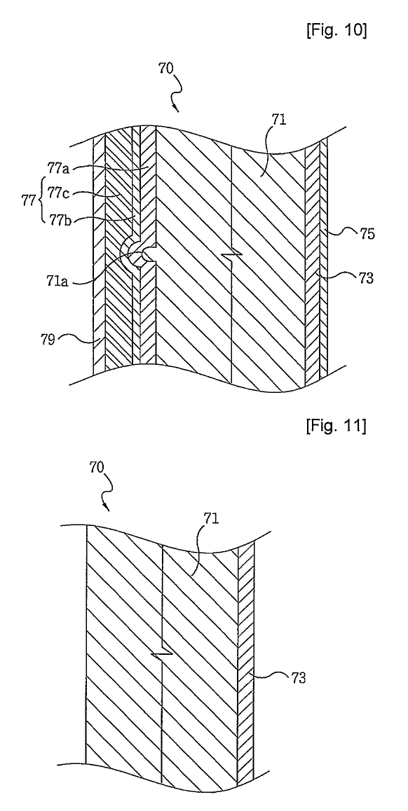

FIGS. 11 to 17 illustrate the method for manufacturing the outer casing of the refrigerator in accordance with another embodiment of the present invention.

As illustrated in FIGS. 11 to 17, a rear film layer 73 and a rear paint layer 75 are formed on a rear face of a base plate 71 by sequentially coating respectively a phosphate at thicknesses of about 50 μm and a paint at thicknesses of about 20 μm. In addition, first and second front paint layers 77a and 77b are formed on the front face of the base plate 71 by sequentially coating respectively a transparent colorless paint at thicknesses of about 50 μm and a predetermined color paint at thicknesses of about 20 to 25 μm.

The base plate 71 provided with the rear film layer 73, the rear paint layer 75 and the first and second front paint layers 77a and 77b passes between rolling rollers 80 and 80′ to be rolled. Here, a pattern 71a is formed on the front face of the base plate 71 in a shape of an uneven portion 81 of the outer circumference of the rolling roller 80 closely adhered to the front face of the base plate 71.

In a state where the pattern 71a is formed on the front face of the base plate 71, a third front paint layer 77c is formed on the surface of the second front paint layer 77b by coating a transparent colorless paint at a thickness of about 40 to 50 μm. A protection vinyl layer 79 which is a vinyl sheet with a thickness of about 50 to 100 μm is adhered to the surface of the third front paint layer 77c, thereby finishing manufacturing of the outer casing 70.

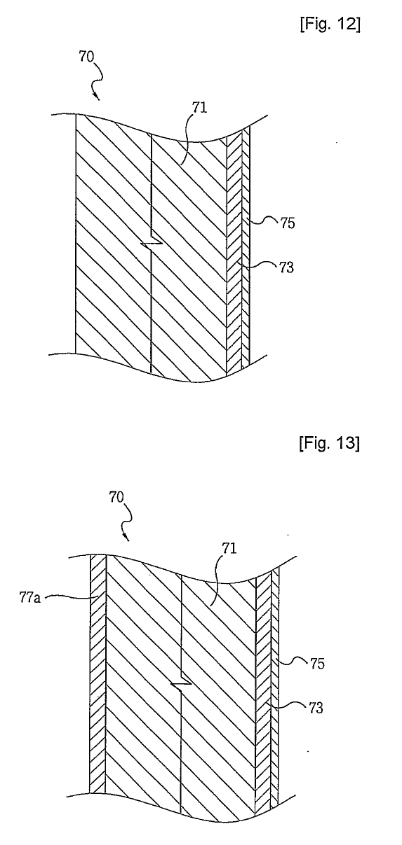

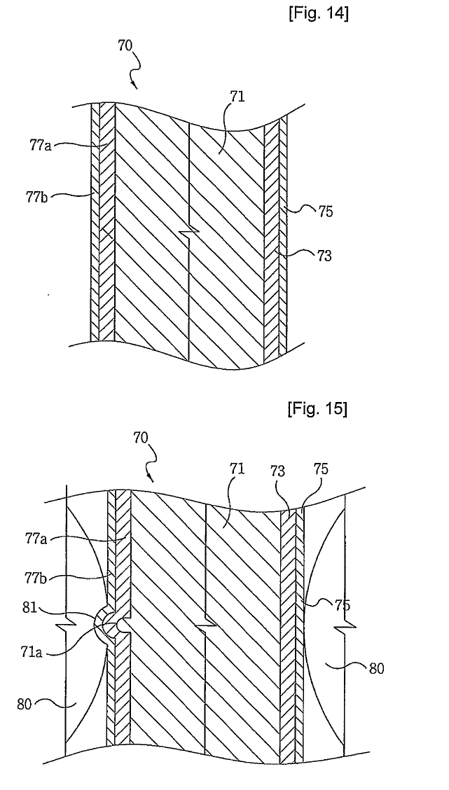

FIG. 18 is a view illustrating a refrigerator with an outer casing in accordance with one embodiment of the present invention, and FIG. 19 is a view illustrating subject portions of the outer casing of the refrigerator in accordance with the present invention.

Referring to FIG. 18 and FIG. 19, a main body 100 of a refrigerator is formed in an almost rectangular shape, and the outward appearance of the main body 100 is defined by an outer casing. The outer casing includes doors 140 and 140′. The front face of the outer casing is defined by the doors 140 and 140′. The doors 140 and 140′ are mounted to be pivotable on one side of the main body 100, for selectively shielding a refrigerating chamber 120 and a freezing chamber defined inside the main body 100. In addition, exterior finishing materials are installed on the front faces of the doors 140 and 140′.

The exterior finishing materials are glass members 200 provided with relatively high strength by heat hardening and installed on the front face of the outer casing. Etching processed images 220 are formed on the glass members 200.

In detail, the glass members 200 correspond in size to each face of the outer casing of the main body 100 of the refrigerator, and are mounted on the outer casing. The thickness of the glass members 200 ranges from about 5 to 10 mm.

The images 220 can be formed in various shapes on the front faces of the glass members 200 by the etching. Target images are sketched on the front faces of the glass members 200, and cut by sand or corroded by a chemical agent along the design.

The method of forming the image 220 on the glass member 200 will now be explained in detail.

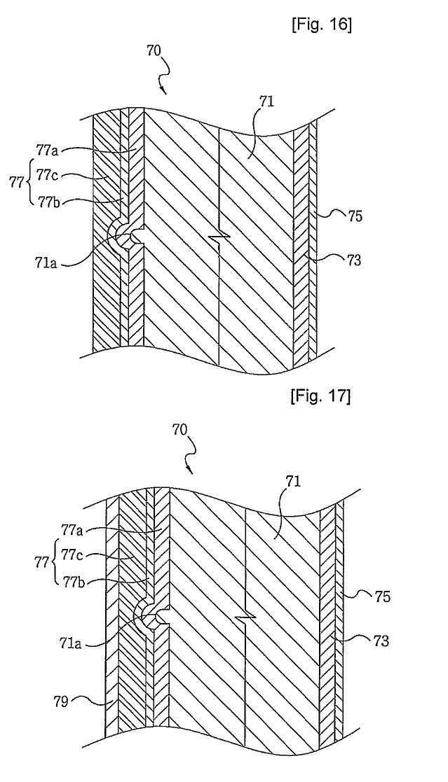

FIG. 20 is a flowchart showing a process of manufacturing an exterior finishing material of a refrigerator in accordance with the present invention.

As illustrated in FIG. 20, the process of manufacturing the exterior finishing material of the refrigerator includes a sketch step (S100) for sketching the image 220 in a target shape on the front face of the glass member 200, and an etching step (S200) for processing the designed pattern portion along the shape sketched in the sketch step (S100).

In the sketch step (S100), a method of printing a design pattern on the front face of the glass member 200 is varied according to a processing method of the etching step (S200) discussed later.

In detail, when the etching step (S200) is performed by using a corrosion solution, a design pattern is printed with a protection film for preventing oxidation by the corrosion solution is formed at a non-etched portion of the front face of the glass member 220. When the etching step (S200) is performed by using sand, a design pattern is printed on the front face of the glass member 200 to mark the portion to be cut by sand.

Meanwhile, a pattern composition process (C100) for selecting a design pattern is performed before the sketch step (S100). In the pattern composition process (C100), a design the consumer prefers can be selected and applied to the exterior finishing material.

After the pattern composition process (C100) and the sketch step (S100) are finished, the etching step (S200) is carried out.

In the etching step (S200), the processing method is determined according to the method of printing the image 220 on the front face of the glass member 200 in the sketch step (S100). First, the processing method using the sand (hereinafter, referred to as ‘sand cutting processing’) will now be explained.

In order to perform the etching step (S200) using the sand cutting processing, in the sketch step (S100), the portion to be cut is sketched on the front face of the glass member 200.

After the portion to be cut is sketched, it is processed along the line by a processing device (not shown) for blowing high pressure fine sand on the glass member 200. Here, the cutting depth is dependent upon the thickness of the glass member 200. Preferably, the cutting depth does not exceed half a thickness of the glass member 200 in consideration of the strength of the finished glass member 200.

The sand cutting processed portion is semitransparent.

In the meantime, the processing method using the chemical agent (hereinafter, referred to as ‘chemical agent processing’) is performed to obtain a more complicated design than the sand cutting processed design.

So as to perform the etching step (S200) using the chemical agent, in the sketch step (S100), the protection coating film is printed on the front face of the glass member 200 except the portion to be corroded. Accordingly, the coating film is preferably made of a material which is not corroded by hydrogen fluoride used as the corrosion solution.

In a state where the coating film is printed, when the chemical treatment using the chemical agent, namely, hydrogen fluoride is performed on the front face of the glass member 200, the non-coated portion of the glass member 200 is corroded by hydrogen fluoride, to thereby form the design pattern sketched in the sketch step (S100). Identically to the sand cutting processed design pattern, the chemically treated design pattern is semitransparent.

The operation of the exterior finishing material of the refrigerator formed by the above-described manufacturing method will now be described.

In the exterior finishing materials of the refrigerator according to the present invention, the images 220 are formed on the glass members 200 by the etching processing.

The images 220 are cut by the sand or corroded by the chemical agent, so that the processed faces become semitransparent. Therefore, the design patterns engraved on the glass members 200 disperse light. The semitransparent lighting effect produces the soft atmosphere.

As various design patterns are applicable according to the tastes of the consumers, the value of the refrigerator is raised from a general electronic product to an art work expressing the beauty. Thus, the refrigerator functions as part of the interior decoration.

The present invention is not limited to these preferred embodiments but various changes and modifications can be made by one skilled in the art within the spirit and scope of the present invention.

For example, in addition to the chemical agent processing method or the sand cutting processing method, a plasma etching processing method can be used as the method for etching the glass member, which obviously belongs to the technical ideas of the present invention of forming the shaped portion by the etching on the glass member used as the exterior finishing material of the refrigerator.

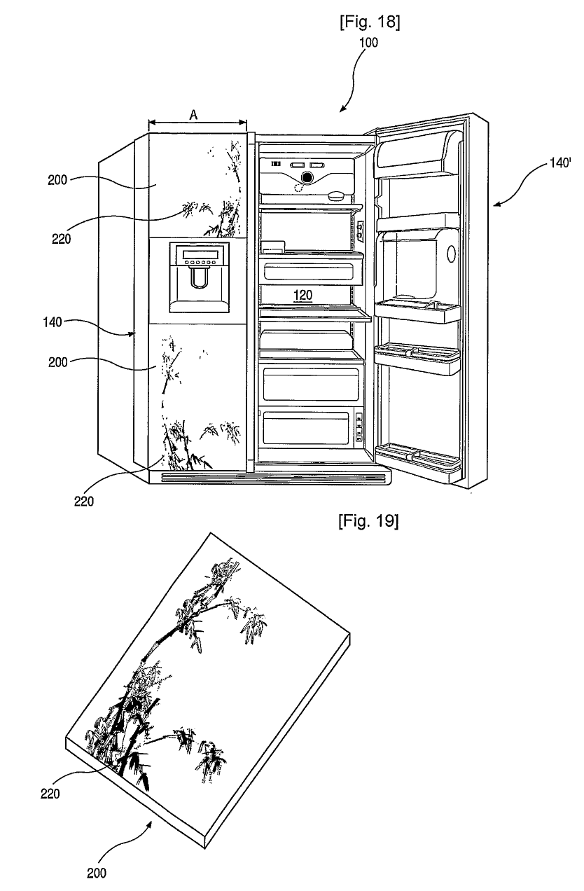

FIG. 21 is a configuration view illustrating an cater casing of a refrigerator in accordance with another embodiment of the present invention. The outer casing of the refrigerator is made of a PCM steel sheet 200. A special design or pattern is formed on the PCM steel sheet 200 by a silk screen printing.

In more detail, as publicly known, the PCM steel sheet 200 includes a base plate 210 made of a material such as a cold rolling steel sheet, a hot dip coated steel sheet and an electrically galvanized steel sheet which are raw materials with excellent workability and outward appearance, a chemical conversion layer 220 surface-processed on the top face of the base plate 210 to have the corrosion resistance and the oxidation resistance, and a primer layer 230 formed on the top face of the chemical conversion layer 220.

The primer layer 230 serves to adhere a coating layer 240 explained later to the chemical conversion layer 220. The coating layer 240 is formed by coating various resins, such as modified polyester, silicon polyester and fluororesin. As various colors can be expressed on the coating layer 240, the coating layer 240 decides the color of the whole outward appearance of the PCM steel sheet 200.

A protection film layer 260 made of a resin is formed on the top face of the coating layer 240, for protecting the coating layer 240. A print layer 250 is formed on the top face of the protection film layer 260, namely, on the surface of the topmost layer of the PCM steel sheet 200, for expressing a special design or pattern.

The print layer 250 is printed according to a silk screen printing method. Preferably, an ink for iron sheet is used so that the print layer 250 can be printed on the protection film layer 260 with the relatively smooth surface. Various materials, preferably, oil enamel, alcohol resin enamel or metal ink can be used as the ink for iron sheet.

Meanwhile, the silk screen printing is also called a screen printing. A silk or an artificial fiber cloth is tightly stretched and employed as a screen, and a non-print portion is covered with a paper pattern or a glue material. When an ink is applied thereon, it is printed only on a print portion through the screen.

As the silk screen printing is not limited in a color number, size or material, it is applicable to metal as well as glass and ceramic.

The print layer 250 printed according to the silk screen printing method is printable on the smooth protection film layer 260 by using the ink for iron sheet. The print layer 250 can be formed by sintering without requiring a special process such as compression.

On the other hand, a plurality of screening sheets must be provided so that various colors of designs or patterns can be expressed on the print layer 250. To this end, a printing process is successively repeatedly performed according to the screening sheets.

The print layer 250 may be exposed to the outside. Alternatively, a clear layer (not shown) made of a synthetic resin may be formed on the top face of the print layer 250 to protect the print layer 250 from the external environment or resistance and prevent the exfoliation of the print layer 250.

The clear layer protecting the print layer 250 from the external resistance is transparent to expose the design or pattern of the print layer 250. The clear layer makes the outward appearance of the PCM steel sheet 200 more tasteful and elegant.

Although not illustrated, if necessary, the top face of the clear layer may be embossed to improve the color and texture of the PCM steel sheet 200.

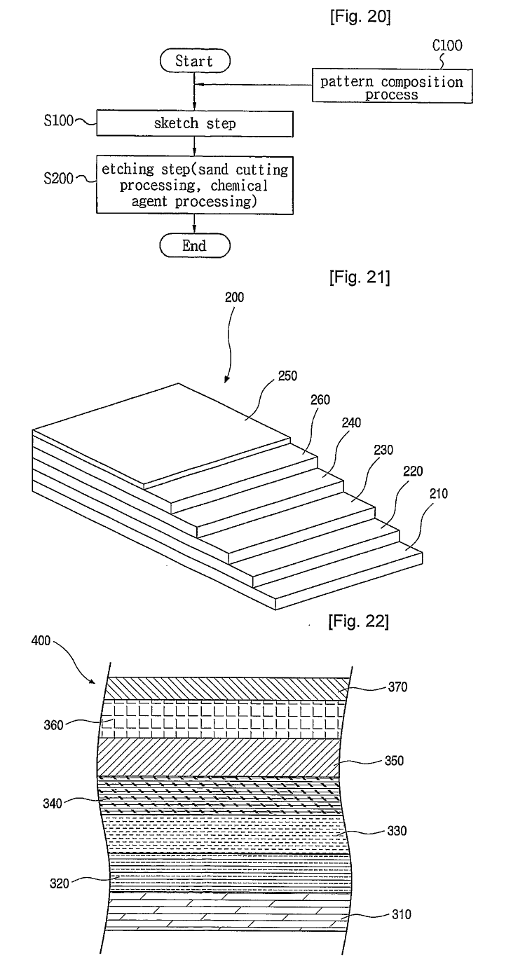

FIG. 22 is a configuration view illustrating an outer casing of a refrigerator in accordance with yet another embodiment of the present invention. The outer casing of the refrigerator is made of a VCM steel sheet 300. A special design or pattern is formed on the VCM steel sheet 300 by a silk screen printing.

As publicly known, the VCM steel sheet 300 is formed by sequentially stacking a rear coating layer 310, a base plate 320, a surface processed layer 330, an adhesive layer 340, a PVC layer 350 and a PET layer 360. The configuration of the VCM steel sheet 300 is identical to that of the general VCM steel sheet, and thus detailed explanations thereof are omitted.

In the meantime, a print layer 370 is formed on the top face of the PET layer 360 which is the topmost layer of the VCM steel sheet 300. That is, the print layer 370 for giving a special design and pattern to the VCM steel sheet 300 is printed according to the silk screen printing method described above. If necessary, a clear layer (not shown) may be formed on the top face of the print layer 370.

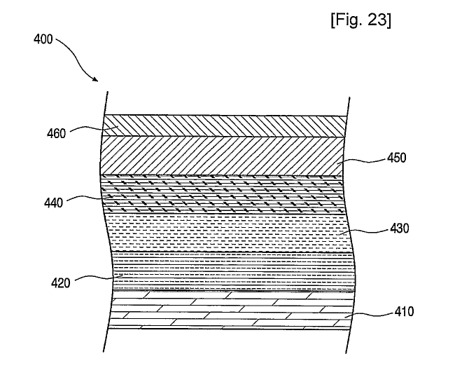

FIG. 23 is a configuration view illustrating an outer casing of a refrigerator in accordance with yet another embodiment of the present invention. As shown in FIG. 23, the outer casing of the refrigerator is made of a PET steel sheet 400. A special design or pattern is formed on the PET steel sheet 400 by a silk screen printing.

The PET steel sheet 400 is similar in structure to the VCM steel sheet 300. In more detail, the PET steel sheet 400 includes a rear coating layer 410, a base plate 420, a surface processed layer 430, an adhesive layer 440 and a PET layer 450 from the bottom. The configuration of the PET steel sheet 400 is identical to that of the general PET steel sheet, and thus detailed explanations thereof are omitted.

Meanwhile, identically to the VCM steel sheet 300, the PET steel sheet 400 includes the PET layer 450 as the topmost layer. Therefore, a print layer 460 can be formed on the topmost layer of the PET steel sheet 400 by the silk screen printing, and a special design or pattern can be formed on the print layer 460.

Differently from the gravure printing method, the silk screen printing method does not need a high temperature compression process. Accordingly, the print layers 250, 370 and 460 can be formed on the surfaces of various color steel sheets, such as the PCM steel sheet 200, the VCM steel sheet 300 and the PET steel sheet 400.

That is, the print layers 250, 370 and 460 with the special designs or patterns formed thereon can be formed on the face of the color steel sheets, such as the PCM steel sheet 200, the VCM steel sheet 300 and the PET steel sheet 400 of various colors and excellent gloss effect. The steel sheets 200, 300 and 400 with the designs and patterns formed thereon can be appropriately processed to form the doors 120 and 140 of the refrigerator or define the outward appearance of the main body 100.

Although the preferred embodiments of the present invention have been described, it is understood that the present invention should not be limited to these preferred embodiments but various changes and modifications can be made by one skilled in the art within the spirit and scope of the present invention as hereinafter claimed.

1. An outer casing of a refrigerator, comprising a layer defining the outward appearance of the refrigerator and having an image formed thereon.

2. The outer casing of claim 1, wherein the layer with the image formed thereon is a base plate, the outer casing further comprising:
a rear film layer positioned on the rear face of the base plate;
a rear paint layer positioned on the rear face of the rear film layer and
a front paint layer positioned on the front face of the base plate.

3. The outer casing of claim 2, wherein the image formed on the base plate is an uneven portion.

4. The outer casing of claim 3,
wherein the uneven portion of the base plate is traced to the front paint layer to form an uneven portion thereon.

5. The outer casing of claim 2,
wherein the front paint layer includes a first front paint layer formed on the front face of the base plate by coating a paint, and a second front paint layer formed on the surface of the first front paint layer by coating a paint.

6. The outer casing of claim 4,
wherein the front paint layer further includes a third front paint layer formed on the surface of the second front paint layer by coating a paint.

7. The outer casing of claim 6,
wherein the first and third front paint layers are formed by coating a transparent colorless paint, and the second front paint layer is formed by coating a predetermined color paint.

8. The outer casing of claim 7,
further comprising a protection vinyl layer adhered to the surface of the third front paint layer.

9. The outer casing of claim 1,
wherein the layer with the image formed thereon is a glass member, and the image is formed by etching the glass member.

10. The outer casing of claim 9, wherein the thickness of the glass member ranges from 5 to 10 mm.

11. The outer casing of claim 1,
further comprising a color steel sheet,
wherein the layer with the image formed thereon is a silk screen print layer prepared by forming an image on the surface of the topmost layer of the color steel sheet with an ink for iron sheet.

12. The outer casing of claim 11,
wherein the color steel sheet is any one of a VCM steel sheet, a PCM steel sheet and a PET steel sheet.

13. The outer casing of claim 11,
further comprising a clear layer formed on the top face of the silk screen print layer by coating a transparent synthetic resin, for protecting the silk screen print layer.

14. The outer casing of claim 11,
wherein the ink for iron sheet is any one of oil enamel, alcohol resin enamel and metal ink.

15. The outer casing of claim 11,
wherein the silk screen print layer includes a plurality of silk screen print layers with different images sequentially silk screen printed.

16. A method for manufacturing an outer casing of a refrigerator, comprising the steps of:
forming an image on at least one layer of the outer casing of the refrigerator; and
molding the outer casing of the refrigerator including the layer with the image formed thereon.

17. The method of claim 16,
wherein the step of forming the image comprises a process of forming a predetermined image on a base plate.

18. The method of claim 17,
wherein the process of forming the predetermined image on the base plate is a process of forming an uneven portion on the base plate by rolling the base plate with a rolling roller.

19. The method of claim 17,
wherein the step of forming the image further comprises the process of forming a rear film layer on the rear face of the base plate, the process of forming a rear paint layer on the rear face of the rear film layer, and the process of forming a front paint layer on the front face of the base plate.

20. The method of claim 19,
wherein the process of forming the front paint layer includes a first front paint layer formation process of coating a transparent colorless paint on the front face of the base plate, and a second front paint layer formation process of coating a predetermined color paint on the surface of the first front paint layer.

21. The method of claim 16,
wherein the step of forming the image includes the process of sketching the image on a glass member, and the process of performing an etching along the sketched image.

22. The method of claim 21,
wherein the process of performing an etching the glass member is etched by using a high pressure fine sand wind.

23. The method of claim 21,
wherein the process of performing an etching the glass member is etched by corrosion using a chemical agent.

24. The method of claim 23,
wherein the process of performing an etching the glass member is etched by corrosion using hydrogen fluoride.

25. The method of claim 16,
wherein the step of forming the image includes a process of forming a silk screen print layer by performing a silk screen printing on a topmost layer of a material with an ink for iron sheet.
